(19) United States
(12) Patent Application Publication
(10) Pub. No.: US 2006/0266265 A1
(43) Pub. Date: Nov. 30, 2006

(54) Method and apparatus for producing a multilayer cementitious product

(75) Inventors: Samantha Jane O'Keefe, Loughborough (GB); Andreas Wicht, Cotgrave, Nottinghamshire (GB); Matthew James Wood, East Leake (GB)

Correspondence Address: BIRCH STEWART KOLASCH & BIRCH, PO BOX 747, FALLS CHURCH, VA, 22040-0747, US

(73) Assignee: BPB PLC, Slough (GB)

(21) Appl. No.: 10/531,309

(22) PCT Filed: Oct. 15, 2003
(86) PCT No.: PCT/GB03/04445

§ 371 Date: Feb. 9, 2006

(30) Foreign Application Priority Data
Oct. 15, 2002 (GB) 0223875.6

(51) Int. Cl. C04B 28/14

(52) U.S. Cl. 106/778

(57) ABSTRACT

A method of manufacturing a multilayered cementitious product comprising the steps of combining a cementitious material with water within a mixing container so as to form an aqueous slurry discharging the slurry from said mixing container through an outlet onto a support and inserting a setting accelerator into said slurry at or close to the outlet of the mixing container.

This invention relates to a method and apparatus for manufacturing cementitious based products such as prefabricated building components. Examples of such products include gypsum plasterboards, partition panels, ceiling tiles and fibre-reinforced boards.

Gypsum is the common name for calcium sulphate CaSO4 in mineral form and the hemihydrate form, also known as stucco or Plaster of Paris, is produced by heat conversion of the dehydrate gypsum. Stucco is the primary constituent used in the manufacture of the aforementioned products.

Products such as gypsum plasterboard are produced from the basic materials, paper in the form of cardboard, stucco, water, starch and some additives such as an accelerator and retarder and foam. Wallboards or plasterboards are large thin gypsum panels covered with cardboard. The stucco is fed into a continuous mixer with water and the additives. The slurry produced is then fed onto a continuous sheet of cardboard, covered with a second sheet of cardboard and then passed over a moulding platform to be shaped into an encased strip. This strip of gypsum plasterboard is initially soft but then quickly sets and therefore hardens and is cut into separate panels. The panels are dried and finished as required.

It is important that the plaster board is sufficiently set by the time it reaches the board cutter. Plaster boards are manufactured on a continual basis and the position of the cutter varies depending on the plant characteristics. It is commercially desirable that the production rate of the plaster board is increased and therefore the time taken for the board to reach the cutter is reduced.

Ceiling tiles and partition panels are produced by a similar process although the slurry is poured into moulds to produce the desired shape and size. If fibreboards are required the slurry also contains suitable fibres such as glass or paper fibres.

The setting and hardening of the slurry can be controlled by numerous additives. Accelerators such as inorganic acids and their salts such as potassium or sulphuric acid and their salts are especially useful. Ca S0₄.2H₂0 (ground gypsum mineral mixed with soap (Nansa)) is commonly used. Accelerators enable the slurry to set more quickly, in part, by increasing the solubility of the gypsum.

Accelerators are essential for quickening the setting and hardening of the slurry, however retarders are also used to control the rapid water uptake and often comprise water-soluble hydrophilic colloids such as proteins. This enables the soft plaster slurry to remain plastic until the process has been completed resulting in better bonding to the base.

In known gypsum manufacturing processes all the additives are metered into a mixer where they are fully combined with the slurry before being extruded onto the cardboard or fed into moulds. However in some instances the setting and hardening process occurs too quickly, in the mixer itself, causing hydration in the mixer or lumps in the extruded mixture.

According to the present invention there is provided a method of manufacturing a multilayered cementitious product comprising the steps of combining a cementitious material with water within a mixing container so as to form an aqueous slurry, discharging the slurry from said mixing container through an outlet onto a support, inserting a setting accelerator into said slurry at or close to said outlet.

Advantageously the accelerator is introduced into the cementitious slurry without being wholly introduced into the mixing container, thus avoiding the possibility of full or partial setting or hardening of the slurry within the mixer and hence damage to the mixer itself. Also sufficient amounts of the accelerator can be introduced to the plaster slurry to provide a much faster set and hydration of the board in production without causing any setting or hydration in the mixer.

The accelerator may be inserted into the slurry at the entrance to the mixer container outlet. Advantageously the introduction of the accelerator at the entrance to the outlet enables the accelerator to mix with the slurry from the mixer before it is transferred to the paper or cardboard support.

The accelerator may be inserted into the slurry of said mixing container at the onset of turbulence in said mixture when it is directed into said mixer container outlet. Advantageously the accelerator mixes with the slurry without the need to be combined with the slurry in the mixer itself, as is the case with known processes. The turbulence of the mixture as it enters the mixer outlet provides enough agitation to mix the accelerator into the slurry.

The accelerator may comprise at least one of the aluminium sulphate, zinc sulphate and potassium sulphate or other water soluble salts which form a sulphate when mixed.

The accelerator may be in the form of a powder.

The accelerator may be in the form of an aqueous solution.

The accelerator may alternatively be in the form of a slurry.

The accelerator may comprise wet ground gypsum.

The cementitious material may be gypsum plaster or stucco.

The support may be paper or cardboard sheet.

The outlet may be a conduit.

A second paper or cardboard sheet may be applied over the slurry located on said first support.

Also according to the present invention there is provided apparatus for manufacturing a cementitious product comprising a mixing chamber for mixing a cementitious material with water to produce a slurry, an outlet for directing said slurry onto a support wherein means for delivering an accelerator for increasing the setting or hardening speed of said slurry is located close to or at the mixer outlet such that said accelerator is fed into said slurry before it is located on said support.

The outlet of the apparatus may be a conduit.

The means for delivering said accelerator may comprise a feed conduit connected to said outlet.

The outlet conduit may comprise an entrance and an exit, said slurry being delivered to said conduit from said mixer and said accelerator feed conduit being connected to said mixer outlet conduit at the outlet conduit entrance.

The support may comprise a sheet of cardboard or paper.

A second sheet of cardboard or paper may be provided over said slurry and accelerator mixture provided on said first support sheet.

The cementitious product may comprise gypsum plasterboard.

The first support layer may be provided on a moving conveyor.

The invention will now be described by way of example with reference the accompanying drawings in which:

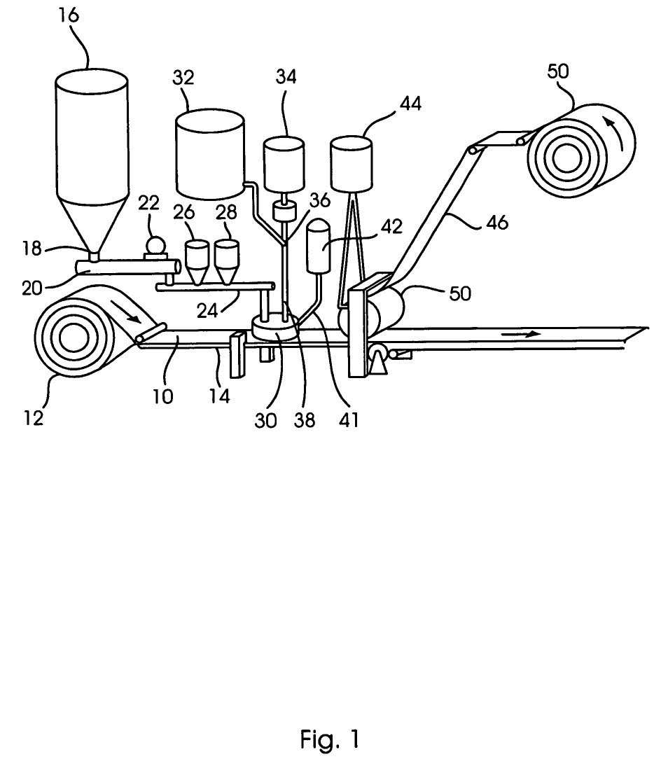

FIG. 1 is a diagrammatic view of plasterboard production apparatus according to an embodiment of the invention.

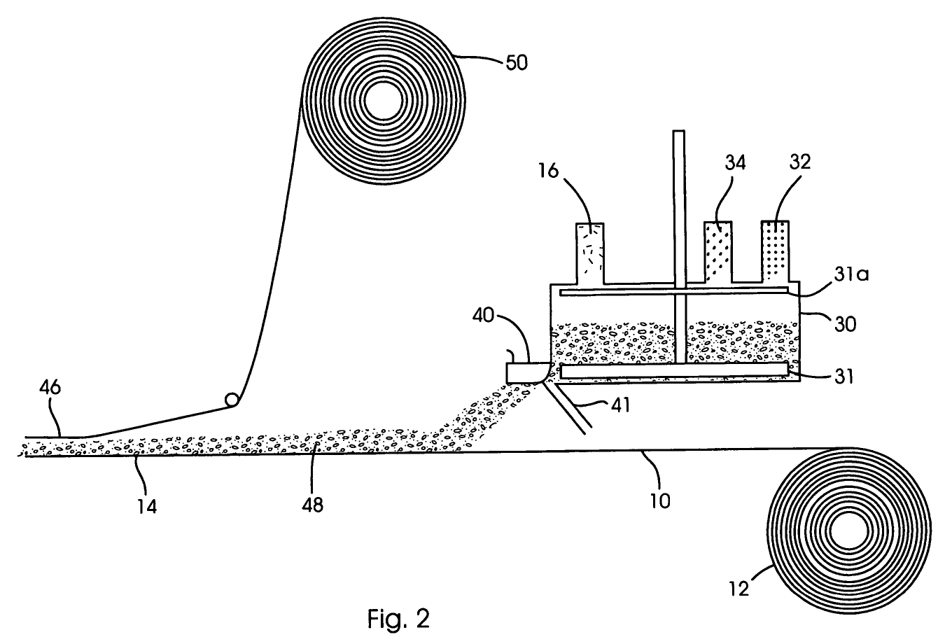

FIG. 2 is a schematic & semi diagrammatic drawing of plasterboard production apparatus according to an embodiment of the invention.

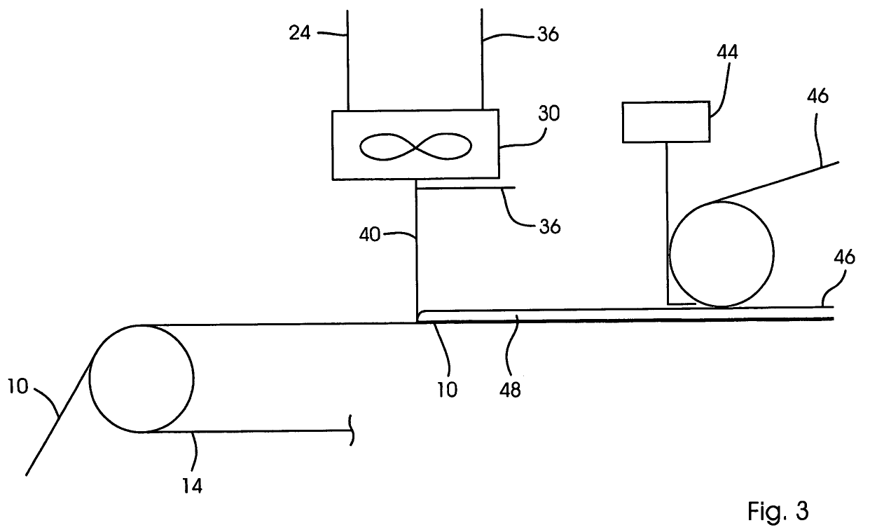

FIG. 3 is a schematic drawing of the mixer of FIG. 1.

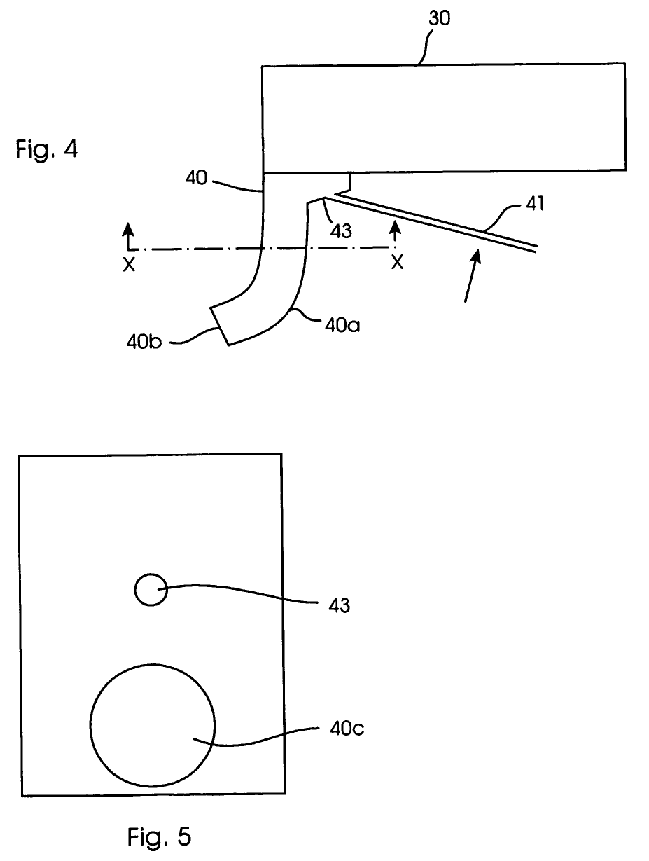

FIG. 4 is a schematic drawing of the mixer outlet of FIG. 2.

FIG. 5 is a view along the line X-X of FIG. 4 without showing the accelerator input conduit.

A first layer of paper 10 is fed from a roll 12 onto a conveyor or belt 14. A storage container 16 contains stucco (β-hemihydrate plaster) and is provided with an outlet 18. The outlet is connected to conduit 20. A meter 22 is connected to said conduit 20 for measuring and controlling the amount of stucco fed through the conduit 20.

A further conduit 24 is connected to the conduit 20 and two further storage containers 26 and 28. Each storage container 26, 28 contains appropriate additives used in the plasterboard process. Such additives may comprise retarders such as organic acids and their salts or adhesives, binders, dispersion aids and other conventional additives imparted in known quantities to facilitate manufacturing.

The conduit 24 is connected at its outlet to a mixer 30. The mixer comprises a cylindrical housing containing a rotating disk shown 31 and scraper blades 31a, as shown in FIG. 2. The scraper blades are positioned and shaped so as to keep the mixer lid free from a build up of plaster.

A water container 32 is connected to the conduit 36 of a further additive storage container 34. The container 34 stores further additives such as foaming agents. The water or further additive conduit is connected to the mixer 30 at its conduit outlet 38.

The mixer 30 is provided with an outlet 40 to deliver its combined contents in the form of a slurry onto the paper 10. As shown in FIG. 4 the plaster slurry is directed from the mixer outlet 40 via a spout 40a onto the paper 14. The spout 40a may be fabricated from steel or other suitable material. The outlet end 40b of the spout 40a may be connected to a flexible conduit) not shown) which guides the plaster slurry onto the paper 14 to minimise splashing. A further storage container 42 contains an accelerator additive such as dehydrate slurry. The accelerator storage container 42 is connected to the mixer outlet 40 via conduit 41 close to where the mixer outlet is connected to the mixer 30. This is shown more clearly with reference to FIG. 4. The mixer outlet 40 essentially comprises an aperture 40c which is also the opening or inlet of the spout 40a. It is to be understood that more than one mixer outlet aperture may be present. These apertures 40 may be formed in the underside of the mixer 30 or may also be positioned tangentially or radially on the mixer 30. The apertures 40 may be of any suitable shape such as elliptical, circular or rectangular. The position of the mixer outlet and the number of outlets required is dependent on the production process speed and other production plant characteristics. The important criterion is that the plaster slurry is required to cover all of the paper 14 it is directed onto.

A further storage container 44 contains a suitable bonding agent for bonding the overlapping edges of the paper 10 and 46. A second layer of paper 46 is stored and fed from a roll 50 to cover the top surface of the slurry 48.

Cementitious, or more specifically, gypsum products, such as plasterboard, are formed by feeding a first layer 10 of paper from a roll 12 onto a moving conveyor or belt. This layer of paper could comprise cardboard of about 0.5 mm thick or any other preferred arrangement of paper.

The stucco stored in storage container 16 is delivered into conduit 20, the amount delivered being metered and controlled by the meter 22. This stucco is combined with additives delivered from the containers 24 and 26 and fed into the mixer 30. Other additives are combined with water from the water and additive storage containers 32 and 34. This mixture is combined in the mixer 30 to produce a slurry which is then delivered through an outlet pipe 40 onto the paper 10 provided on the moving belt 14.

The accelerator, for example dehydrate, is fed via a conduit 41 into the slurry 48 from the mixer 30 at the entrance to the mixer outlet 40. Advantageously the accelerator is not fed into the top of the mixer 30 as is the case with the other additives, but only introduced through an aperture 43 formed in the outlet 40 of the mixer 30. Thus the effects of the accelerator, for example to quicken the hardening or setting of the slurry are not produced in the mixer itself.

It is envisaged that the accelerator may be any known accelerator in any suitable form such as powder or liquid slurry. However it is proposed to use an accelerator comprising a ground mineral slurry such as finely ground gypsum using a wet milling process or desulphogypsum (a by product created from the removal of sulphur dioxide from flue gases at coal fired power stations).

The mixed slurry contained and delivered from the mixer 30 is provided in a turbulent state at the entrance to the mixer outlet 40. Thus the accelerator is mixed well with this turbulent mixture delivered to the outlet 40 from the mixer 30 despite not having been conventionally mixed in the mixer. This homogenous mix of accelerator and cementitious slurry from the mixer may also advantageously produce a shorter setting time of the plaster.

It is not essential to the invention that the accelerator is delivered directly into the mixer outlet 40 but rather that it is delivered to the slurry of the mixer close to its exit from the mixer 30.

The slurry stream 48 is then provided with a bonding agent or adhesive and a further layer of paper 46 is provided over its upper surface. The slurry is therefore sandwiched between the two sheets of paper or cardboard 10 and 46. These two sheets become the facings of the resultant gypsum board.

The thickness of the resultant board is controlled by a roll 50 and the board is subsequently prepared by employing appropriate mechanical devices to cut or score, fold and glue the overlapping edges of the paper cover sheets 10, 46. Additional guides maintain board thickness and width as the setting slurry travels on the moving conveyor belt. The board panels are cut and delivered to dryers to dry the plasterboard.

Advantageously by adding the accelerator to the outlet 40 of the mixer 30 sufficient amounts of accelerator can be added which may produce a faster setting time than would be provided by the conventional method of adding the accelerator to the mixer. Also the need for ‘retarders’ (chemicals added to the mixer to delay the onset of setting) may also be removed. Such retarders are expensive and are also known to be detrimental to the board produced and further complicate the manufacturing process. Also the problems associated with early setting of plaster in the mixer may be alleviated.

1. Method of manufacturing a multilayered cementitious product comprising the steps of
a) combining a cementitious material with water within a mixing container so as to form an aqueous slurry,
b) discharging the slurry from said mixing container through an outlet onto a support,
c) inserting a setting accelerator into said slurry at or close to said outlet.

2. A method according to claim 1 wherein the accelerator is inserted into the slurry at the entrance to the mixer container outlet.

3. A method according to claims 1 wherein the accelerator is inserted into the slurry of said mixing container at the onset of turbulence in said mixture when it is directed into said mixer container outlet.

4. A method according to any one of the preceding claims wherein the accelerator comprises a water soluble salt which forms a sulphate when employed as an accelerator.

5. A method according to any one of the preceding claims wherein the accelerator is in the form of a powder.

6. A method according to any one of the preceding claims wherein the accelerator is in the form of an aqueous solution or formed from a mix of an aqueous solution.

7. A method according to any one of the preceding claims wherein the accelerator is in the form of a paste.

8. A method according to any one of the preceding claims wherein the accelerator is in the form of a slurry.

9. A method according to any one of the preceding claims wherein the accelerator is in the form of a suspension.

10. A method according to any one of the preceding claims wherein the cementitious material is gypsum plaster or stucco.

11. A method according to any one of the preceding claims wherein the support is a paper or cardboard sheet.

12. A method according to any one of the preceding claims wherein the outlet is a conduit.

13. A method according to any one of the preceding claims wherein the accelerator is in the form of finely wet ground gypsum.

14. A method according to claim 11 wherein a second paper or cardboard sheet is applied over the slurry located on said first support.

15. Apparatus for manufacturing a cementitious product comprises a mixing chamber for mixing a cementitious material with water to produce a slurry, an outlet for directing said slurry onto a support and means for delivering an accelerator for increasing the setting or hardening speed of said slurry wherein said means for delivering an accelerator is located close to or at the mixer outlet such that said accelerator is fed into said slurry before it is located on said support.

16. Apparatus according to claim 15 wherein said outlet is a conduit.

17. Apparatus according to claim 14 or claim 15 wherein said means for delivering said accelerator comprises a feed conduit connected to said outlet.

18. Apparatus according to claim 15 wherein said outlet conduit comprises an entrance and an exit said slurry being delivered to said conduit from said mixer and said accelerator feed conduit being connected to said mixer outlet conduit at the outlet conduit entrance.

19. Apparatus according to any one of claims 15 to 18 wherein said support comprises a sheet of cardboard or paper.

20. Apparatus according to claim 18 wherein a second sheet of cardboard or paper is provided over said slurry and accelerator mixture provided on said first support sheet.

21. Apparatus according to claim 15 wherein said cementitious product comprises gypsum plasterboard.

22. Apparatus according to any one of the preceding claims wherein said first support layer is provided on a moving conveyor.
